(19) United States
(12) Patent Application Publication
(10) Pub. No.: US 2011/0283259 A1
(43) Pub. Date: Nov. 17, 2011

(54) METHOD AND SYSTEM FOR CREATING A PLATFORM APPLICATION WITH MULTIPLE APPLETS

(76) Inventors: Jeffrey Lawson, San Francisco, CA (US); John Wolthuis, San Francisco, CA (US); Evan Cooke, San Francisco, CA (US)

(21) Appl. No.: 13/160,442

(22) Filed: Jun. 14, 2011

Related U.S. Application Data
(63) Continuation-in-part of application No. 12/900,411, filed on Oct. 7, 2010.
(60) Provisional application No. 61/249,491, filed on Oct. 7, 2009.
(60) Provisional application No. 61/354,667, filed on Jun. 14, 2010.

(51) Int. Cl. G06F 9/44

(52) U.S. Cl. 717/121

(57) ABSTRACT

A method and system for creating a telephony application with multiple applets, wherein the applets operate through a telephony platform, including the steps instantiating at least a first applet in an application configuration; adding an applet reference of a second applet in an outlet of the first applet; mapping a telephony endpoint to the first applet in an application configuration; and deploying the application on the telephony platform wherein an incoming communication to the telephony endpoint is routed to the first applet.

### CROSS-REFERENCE TO RELATED APPLICATIONS

This application is a continuation in part of prior application Ser. No. 12/900,411 filed 7 Oct. 2010, titled “SYSTEM AND METHOD FOR RUNNING A MULTI-MODULE TELEPHONY APPLICATION” which is incorporated in its entirety by this reference, and that claims the benefit of U.S. Provisional Application No. 61249491, filed 7 Oct. 2009, titled “SYSTEM AND METHOD FOR CUSTOMIZED TELEPHONY APPLICATIONS” which is incorporated in its entirety by this reference

This application also claims the benefit of U.S. Provisional Application No. 61/354,667, filed 14 Jun. 2010, titled “A SYSTEM AND METHOD FOR BUILDING A CUSTOMIZED TELEPHONY APPLICATION” which is incorporated in its entirety by this reference.

### TECHNICAL FIELD

This invention relates generally to the telephony field, and more specifically to a new and useful method for creating a platform application with multiple applets in the telephony field.

### BACKGROUND

Traditional telephony applications, such as Interactive Voice Response (WR) and Private Branch Exchange (PBX) systems, are used to provide customized telephone services (e.g., an automated phone directory, bill paying, or account info). A telephone application is generally launched through phone actions such as pressing a phone key (e.g., “5”) or speaking a phrase (e.g., “Operator!”). Performing a phone action may launch another IVR or PBX server hosting a different application. In this way, multiple telephone applications are requited to be individually configured and integrated to achieve a desired functionality. Unfortunately, the applications are often sold and operated by different companies. In some situations a single company will offer a variety of first party applications that are designed to work together, but in this situation, a customer is limited to the available options. The applications of different companies may use different telephony hardware and software stacks, and there is no mechanism to transfer call state, meta-data, or call control between applications. Additionally, each of these services may have separate billing contracts and operation costs, that not only can become financially expensive, but also is bothersome to manage. Thus, there is a need in the telephony application field to create a new and useful system and method for creating a platform application with multiple applets. This invention provides such new and useful system and method.

### BRIEF DESCRIPTION OF THE FIGURES

FIG. 1 is a schematic representation of a method of a preferred embodiment;

FIG. 2 is a schematic representation of presenting a customization interface of a preferred embodiment;

FIG. 3 is a schematic representation of delegating a node of a tree model for customization by a second user of a preferred embodiment;

FIG. 4 is a representation of an exemplary phone tree model;

FIG. 5 is a representation of a path of an exemplary phone tree model;

FIG. 6 is a representation of a delegated portion of an exemplary phone tree model;

FIG. 7 is a detailed schematic representation of deploying a container application;

FIG. 8 is a schematic representation of a system for creating a platform application with multiple applets of a preferred embodiment;

FIGS. 9 and 10 are detailed representation of customization platform of a preferred embodiment;

FIG. 11 is a schematic representation of a first preferred embodiment of a deployed customized telephony application;

FIG. 12 is a schematic representation of a configured telephony application;

FIG. 13 is a schematic representation of a variation where a first applet uses a second and third applet within the operation logic of the first applet;

FIG. 14 is a schematic representation of a preferred linking system;

FIGS. 15 and 16 are schematic representations of assigning a usage model;

FIGS. 17 and 18 are schematic representations of transferring payment;

FIGS. 19 and 20 are exemplary representations of screenshots of a customization interface for an application composed of a plurality of applets;

FIG. 21 is a schematic representation of a second preferred embodiment of providing metered API access; and

FIG. 22 is a schematic representation of a system of a preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

1. Method for Creating an Application with Multiple Applets

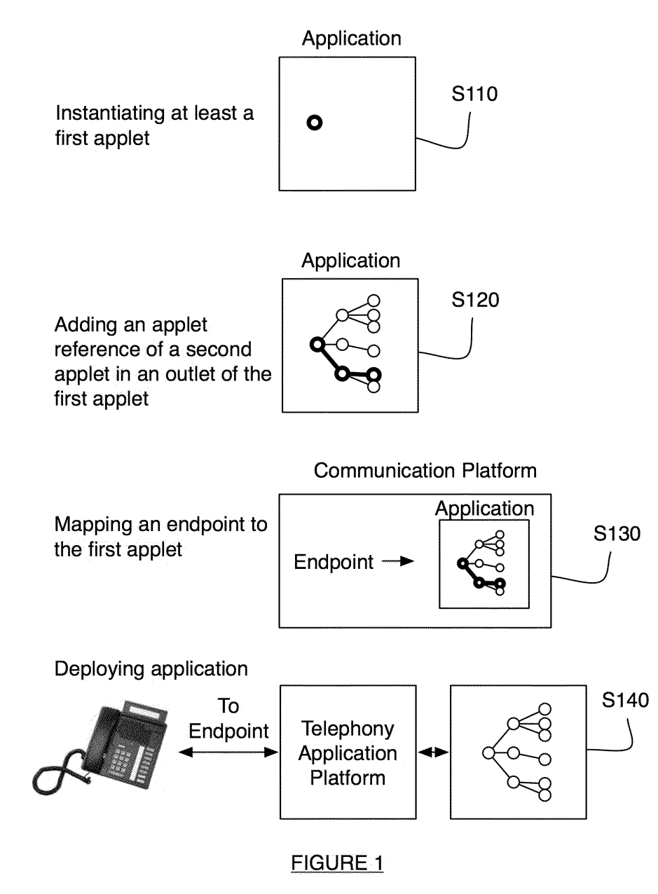

As shown in FIG. 1, a method for creating a platform application with multiple applets of a preferred embodiment includes the steps of instantiating at least a first applet in an application configuration S110; adding an applet reference of a second applet in an outlet of the first applet S120, mapping an endpoint to the first applet S130; and deploying the application on the platform S140. The method functions to make use of a variety of applications and service built on top of a platform. The method is more preferably designed for use with a telephony application to create web-enabled applications for telephony devices. An application created by the method may interface with internet applications, the telephony network, telephone messaging networks (SMS or MMS), fax, email or any suitable network. The multi-applet applications preferably enable developers and possibly common users to create customized applications that utilize pre-built functionality of other applets. The applets may be created by any suitable entity. The method preferably enables users to create a new application utilizing other applications (i.e., applets) from various developers. Additionally, the method preferably includes presenting a customization interface that functions to create an intuitive and easy technique for building a customized application. The method preferably creates a telephony application with distributed functionality. The actual resulting application may be composed of parameters embedded within the functionality of independent applets. Alternatively, central application configuration file may be used to coordinate the passing of control between various applets. Preferably, an application configuration determines some parameters of application operation such as the initial applet passed control.

Step S110, which includes instantiating at least a first applet in an application configuration, functions to setup an applet to be used within the functionality of containing application. Instantiating an applet preferably includes setting an applet reference to be called for a particular state of an application. An applet is preferably a self-contained application that can be passed control of the state. An applet may be a complex application itself made up of other applets or may be a simple single step application. An applet is preferably a telephony application that operates in cooperation with a telephony platform, but may alternatively operate with any suitable platform. In one variation, the applet is an end node (i.e., where a phone session will end). For example, an applet may be a voicemail applet that records a message of the caller and then hangs up. In another variation, the applet preferably directs the caller to other applets. An applet preferably directs a call to another node by referencing at least a second applet as described further below. For example, a directory applet may list names of possible contacts, and connect a caller to a selected contact. An applet is preferably created through a template script filled with instance variables that a user customizes. An instantiated applet preferably has a unique URI that references the applet code or resources used for the node. The URI may additionally include information semantics that preferably include information on the location of the node within the container app such as parent nodes within a phone tree model.

Step S120, which includes adding an applet reference of a second applet in an outlet of the first applet, functions to add a parameter to a first applet that enables a first applet to pass application state control to a second applet. The applet reference is preferably a Uniform Resource Identifier (URI) that is the address for an internet accessible resource of the second applet. Alternatively, an application identifier may be used, which may provide a layer of indirection to an applet reference. The application identifier may be name-spaced locally or globally (e.g., global within the platform). Permissions may additionally be set for an applet and a policy setup to authorize access to a particular applet. An outlet of an applet is preferably any suitable instance variable that is accessed during a particular state of the applet. An applet may be design to have any suitable number of outlets. The outlet is preferably set by setting an associated instance variable of an applet. The applet reference preferably references a customized applet, but may alternatively reference a generic applet. An applet reference to a customized second applet may additionally embed the instance variables of the second applet. Preferably, the instance variables are embedded within the URI of the applet reference. In one alternative variation, URI redirection similar may be used. In this alternative variation, the applet reference preferably references a resource which has access to set instance variables, and can redirect access to a resource of the applet embedding the instance variables. In another alternative, the instance variables of an applet are stored as an accessible resource or stored/accessed in any suitable manner.

Step S130, which includes mapping an endpoint to the first applet, functions to establish a routing from an endpoint to an application. Preferably the endpoint is a telephony endpoint. The telephony endpoint may additionally be distinguished by the protocol used with the endpoint. A voice communication on the endpoint may be mapped to one initial applet, and a telephony endpoint used with a telephony messaging protocol (e.g., SMS or MMS) may be mapped to a second initial applet. Any suitable number of endpoints may be mapped to any suitable initial applets. This functions to create an application that can be customized for different functionality based on the mode of use. Other types of endpoints may include fax, email, or any suitable network may additionally be routed to a suitable destination. An application configuration file is preferably hosted on the platform and includes the various parameters determining this mapping. The application configuration preferably includes URIs (applet references) for initial state control of an incoming communication, and may additionally include fallback URI's for error handling, and any other suitable overall application configuration. In a telephony platform, the routing preferably occurs within a call router of the telephony platform. An incoming communication preferably has the destination address detected. The endpoint with a matching communication protocol is looked up, and the corresponding applet identified. The applet is preferably identified by an applet reference. This first applet may be described as an initial applet (i.e., node of a tree model). When assigning a phone number, a user preferably provides a phone number. The phone number may be verified by the telephony application code calling the phone number and playing a confirmation code that is preferably also supplied by the user back to a customization platform. A phone number may alternatively be confirmed in any suitable manner. A phone number may alternatively be allocated for use with the container application. A phone is preferably allocated in a substantially instantaneous fashion by maintaining a pool of unused phone numbers for allocation. A phone number is preferably selected from this pool for use with the container application.

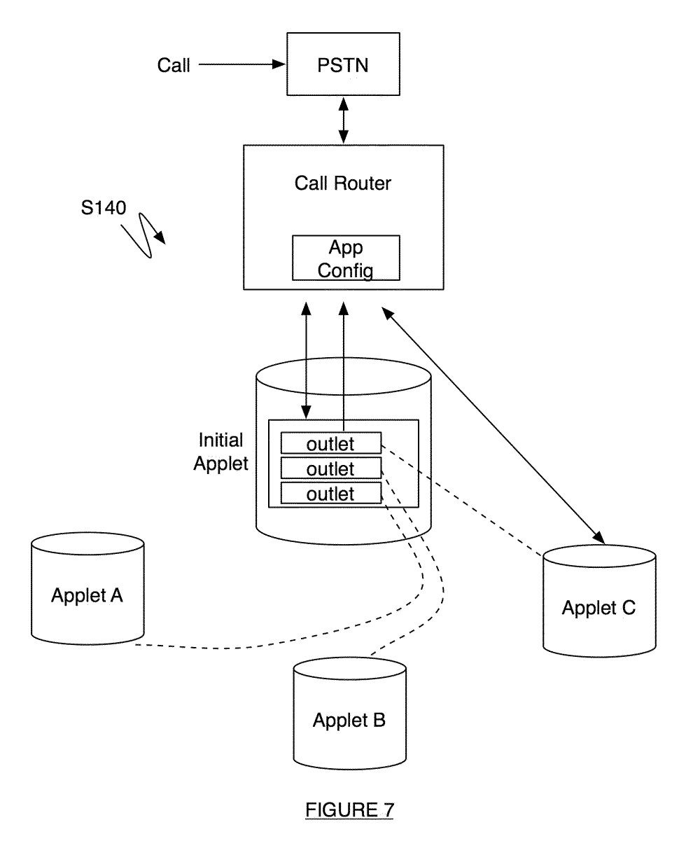

As shown in FIG. 7, Step S140, which includes deploying the application on the platform, functions to run the application for user interaction. Operation of the container app is preferably substantially similar to method 5200 described below but any suitable form of operation may be used. For a telephony application, the telephony platform preferably handles the interfacing between an applet and a telephony device. The applet references when invoked preferably transitions application state control to the associated applet. In deployment, the application configuration is preferably hosted on or made accessible by a call router of the telephony platform. Incoming communications preferably access the application configuration to determine initial state control. The applets are preferably hosted on servers of the applet authors. The applets may alternatively be hosted by internal servers of the communication platform. A call router preferably handles passing requests and handling responses from the container app and/or applets.

The method additionally includes presenting a customization interface that receives user input of at least one instance variable of an applet S150, which functions to enable tangible creation of the application by a user. An instantiated applet may contain instance variables set for a particular operation behavior. The customization interface preferably translates user input to operation configuration of an applet. For example, in a directory applet, the names of contacts and the destination for each contact are preferably instance variables that are set preferably set by a user through the customization interface. In particular the outlets of an applet are preferably an instance variable that is set through the customization interface. In one preferred customization interface, an applet reference to second applet is preferably added to an outlet instance variable of an applet by dragging and dropping a graphical representation of the second applet into an outlet field. Alternatively, the URL of the apple, applet name, or any suitable reference indicator may alternatively be inserted into a customization interface for an applet.

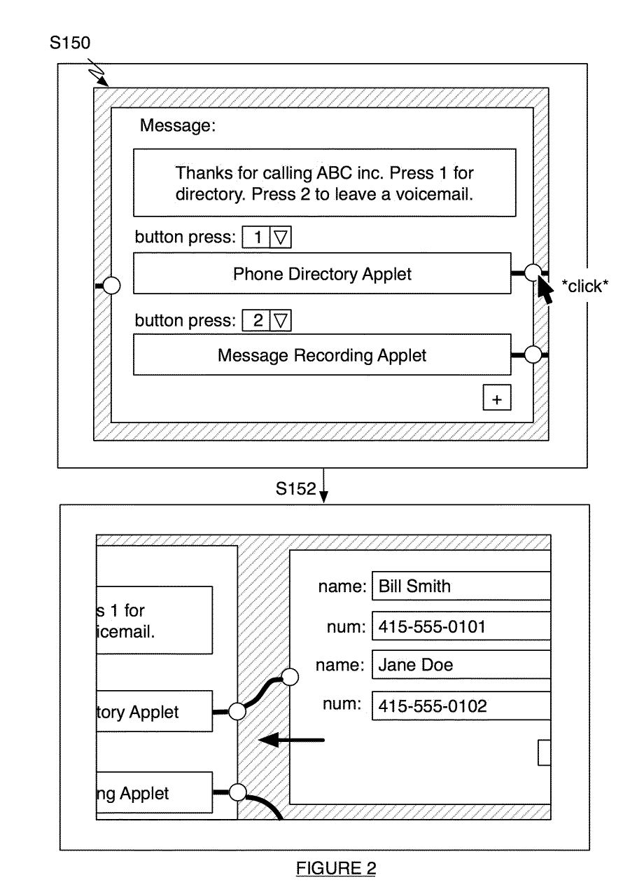

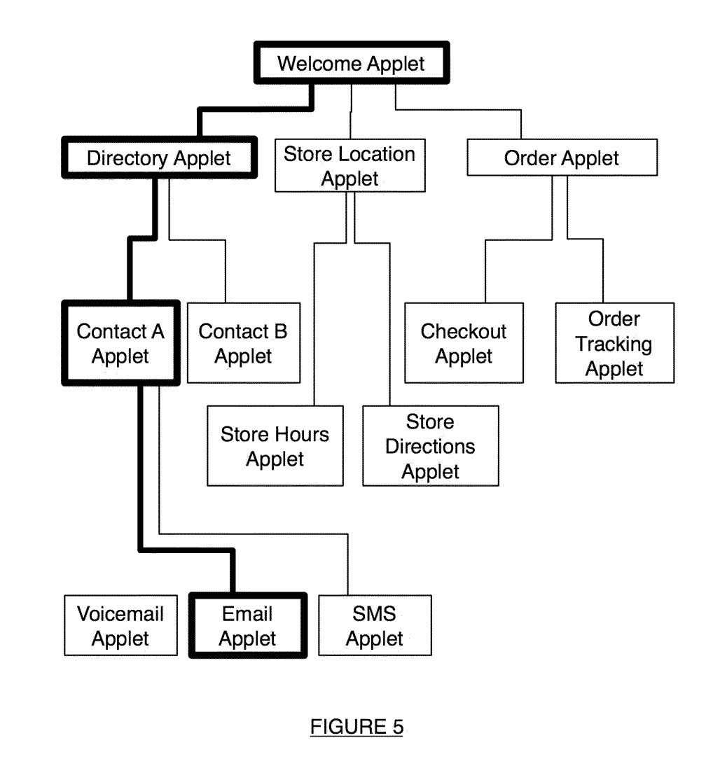

In one preferred embodiment, the presenting a customization interface includes traversing a tree model path for applet instance customization S152, which functions to use a call flow representation for linking applets. Step S152 preferably functions to streamline the production of a container application by making customization of applets integrated into inspection of a call flow of an application. A tree model is preferably defined pathways of applet references from an Applet outlet to another applet. A tree model may alternatively be described as a network of nodes wherein an applet is associated with each node, and an applet reference for each interconnection between nodes. Applet specific customization options are preferably presented as a user graphically navigates a tree model. More preferably, applet specific customization options are modally presented based on the currently selected applet in the tree model. Modal presentation preferably includes presenting customization options where only the currently selected applet can be customized. In traversing the tree model a singular path through a tree model is preferably presented by a customization interface as shown in FIG. 2. A tree model path preferably shows the applets (nodes of a tree model) of a non-branching path through a tree model as shown in FIG. 5. The user preferably navigates through a tree model by selecting which child applet to inspect/customize. Selecting a child applet preferably navigates further along a tree model path by pulling a customization interface (or inspection representation) of the selected child node. Traversing the tree model preferably includes receiving user selection of an inlet or an outlet of a currently selected applet and presenting an applet associated with the inlet or outlet. This is essentially equivalent to selecting an applet reference and navigating to the applet on the other side of the applet reference (e.g., origin or destination).

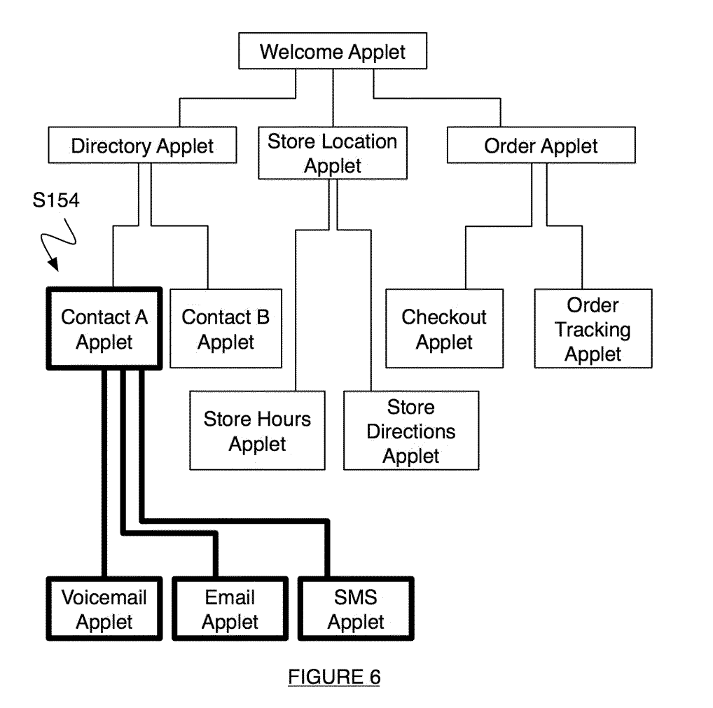

Additionally, the method of a preferred embodiment may include delegating a node of a tree model for customization of a second user S154, which functions to permit other users to design portions of an application. Delegating a node of a tree model preferably enables a user to edit customization instance variables, add applets (build more nodes), and/or make any suitable modification. Adding permissions to edit a node preferably allows the second user to edit an applet and optionally applets that can be accessed through an outlet of the applet as shown in FIG. 6. Delegating a node of a tree model may alternatively enable customization of a particular applet or applets, and may only allow control over a portion of instance variables of an applet, such as a particular input field. Delegating a node is preferably performed by adding editing permissions to the applet URI resource, but may be performed in any suitable manner. For example, a tree model of an application may include a node that is an instantiated directory applet. The original creator of the application may not know how a contact included in the directory wants to handle the call, and so the original creator may adds a child applet for each of the contacts and delegate customization of that node (i.e., the child applet) to the respective contacts. Then each contact can personally setup how they want calls directed to them to be handled.

2. System for Creating an Application with Multiple Applets

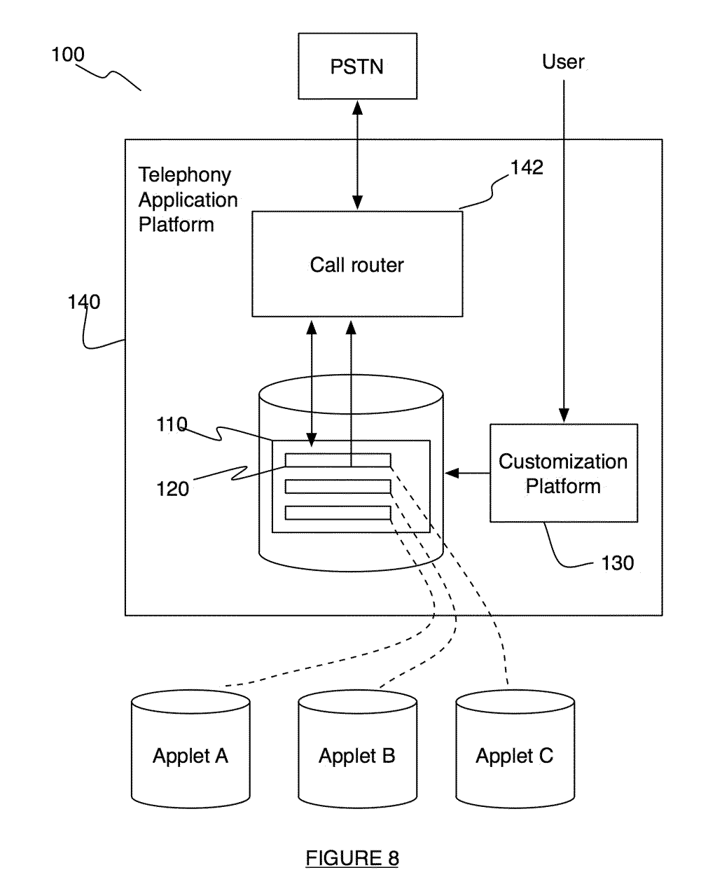

As shown in FIG. 8, the system 100 of the preferred embodiment for customized telephony applications includes an application configuration 110, applet references 120, a customization platform 130, and a telephony application platform 140. The system 100 of the preferred embodiment functions to allow customers to create telephone applications specialized for customer purposes, while still utilizing tools developed by a wide variety of companies and developers. The system 100 further functions to provide an environment enticing for outside developers. Outside developers are able to create applications with arbitrary complexity that may use any necessary resources or technology. Developer applets can be hosted remotely at a site selected by the developer utilizing any suitable architecture, yet the applets can be made available and integrated in other applets in a single marketplace to provide better exposure, and lower the barrier of acceptance by potential customers.

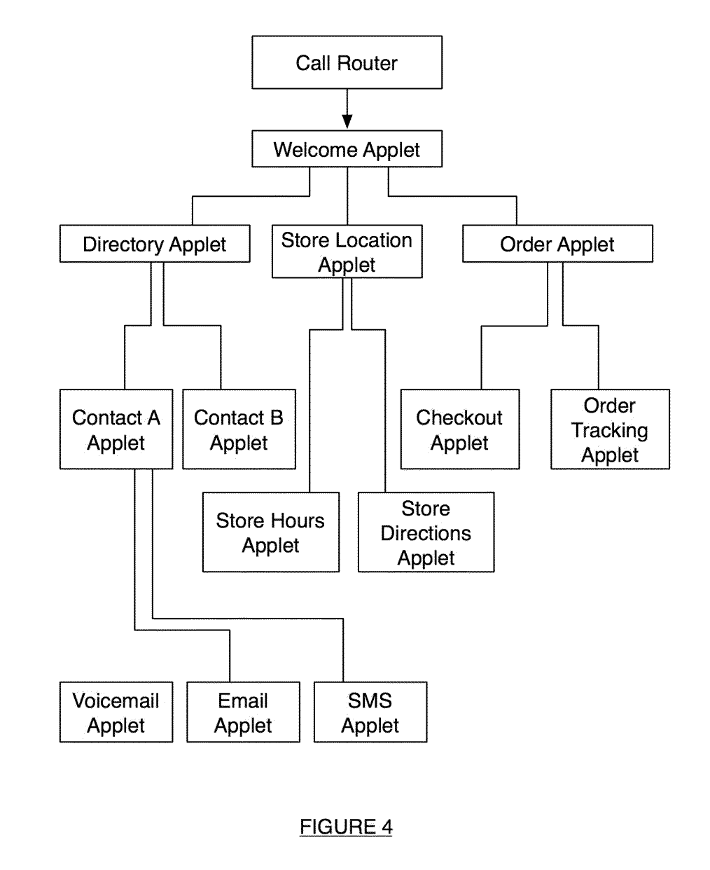

The application configuration (also referred to as “controller app” or container application) no of the preferred embodiment functions to define overall functionality of the telephony application. The application configuration may additionally provide high-level control call flow between applets during a call. The application configuration 110 is preferably is an abstraction of the overall telephony application. The application configuration 110 in some sense functions as a menu or starting point for a call. The application configuration is preferably a datastore of parameters of an application such as the mapping between endpoints/communication protocols and initial applets. Error handling parameters such as fallback URIs (called if an error occurs) or any other global parameters may be stored within the application configuration. The name, icon, description of an application and any suitable descriptive parameters of an application may additionally be part of the application configuration no. The application configuration may additionally define a phone tree model. A phone tree model is preferably a model of telephony application interaction where a user progresses between different nodes of a tree, as shown in FIG. 4. Each node preferably has independently instantiated applet references. Each instantiated node preferably handles call flows between to other nodes (e.g., which child node to progress to). The tree model may alternatively be dynamically determined by following applet references of applets in the application. The application configuration 110 preferably includes a phone number mapping within the telephony application platform that routes incoming phone number calls to the container app no. Actions such as user input (e.g., Dual-Tone Multi-Frequency (DTMF) input or voice commands) or program events (timed event) can preferably launch applets and cause progression to a different applet. The application associated with the application configuration is preferably a customizable program that may have any number of menus and sub-menus to fit the needs of a customer. The menu options preferably include applet references 120, but may alternatively lead to a sub-menu or parent menu or provide any suitable navigation task within a node of the container app 110. The container app no preferably passes off call control to an applet when an applet is encountered during a call state flow. During an instance of an application, an applet may operate in the background or during any suitable operation, the application configuration no may aid in coordinating communication such as storing application global variables. Error checking during an application session may be automatically implemented, a fallback URI set in the application configuration may be used to take over call state when an error occurs. Alternatively application errors may be handled in any suitable fashion. The container app no is preferably created when a new application is created within the customization platform 130.

The applet references 120 of the preferred embodiment function to direct call control to an applet. The applet reference 120 is preferably a Uniform Resource Identifier (URI). The URI may include variables and necessary information within the URI of a Hyper Text Transfer Protocol (HTTP) request, but variables may alternatively be stored elsewhere such as the body or header of an HTTP POST command. The URI may alternatively be shortened using any suitable URI shortening service or be any suitable pointer to applet location. The applet is preferably stored and operated remotely (not within the system) and are preferably generated mostly by third party developers. However the applets may alternatively be developed, stored, and operated by any suitable party such as first party applets operated on local servers. The applet is preferably a telephony application of arbitrary complexity. The applets preferably function independent of the state of the container app or overall functionality. The stateless nature of the applet functions to allow applets to be called without worrying about current state of the call or the effects of other applets. State of a call or of an applet may alternatively be preserved through any suitable practice such as cookies. Management is preferably an available option implemented on the applet side of the system, and the container app and related applets are preferably by default stateless. Applets may additionally include customization that is preferably performed during the setup of an applet on the customization platform 130.

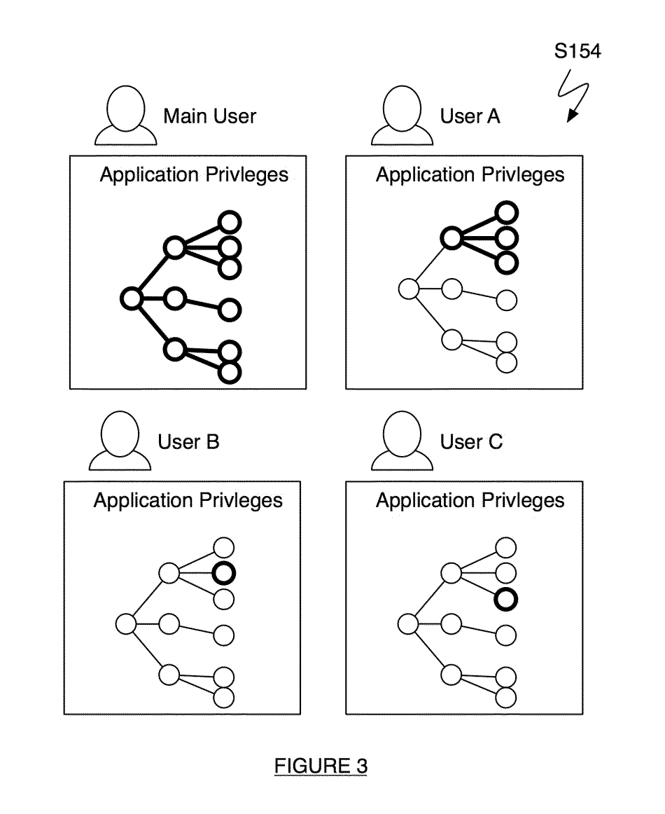

Customization of an applet is preferably made available through an applet customization reference 122 which functions to allow a customization platform 130 to import a form or software necessary for acquiring settings. Permissions may be incorporated into the customization of an applet so that users of a customization platform 130 may be assigned permissions. Permissions are preferably assigned to a node of a tree model as which preferably transfers to child nodes, as shown in FIG. 3. Permissions may alternatively be assigned to any suitable node of a phone tree model. Applets may rely on variables such as sound files, text (to read with a text-to-speech service), phone numbers, email addresses, URIs to other media, other applet references, applet parameters, and/or any suitable variable. Alternatively or additionally, a customized applet may be generated from a customization applet. The applets may perform any suitable function from very simple tasks such as playing a recording, to full customer service telephone applications with customer service representatives. The applet may be a store locator, an e-commerce order status app, call analytics, a find-me application, an RSS feed powered app, a call directory and routing app, an advertising application that calls another applet reference after playing an advertisement, a voicemail app, menu app, a simultaneous call app, a find me app that calls a list of numbers until one of them is answered, or any suitable application.

The customization platform 130 of the preferred embodiment functions to be a point of creation of container apps 110 and distribution of applets. The customization platform 130 is preferably setup as an online store or marketplace. The customization platform may alternatively be a desktop application, telephony application, or any suitable platform that facilitates customization of a telephony application that includes the means to generate a container app 110 and host a list of applets (and related applet reference 120). Customers preferably interface with the customization platform 130 to acquire applets and create and edit settings of container apps no. Developers preferably interface with the customization platform 130 to sell/distribute and manage applets. The customization platform preferably includes a customer portal 132 and developer portal 134 that preferably provides appropriate functionality for the respective parties.

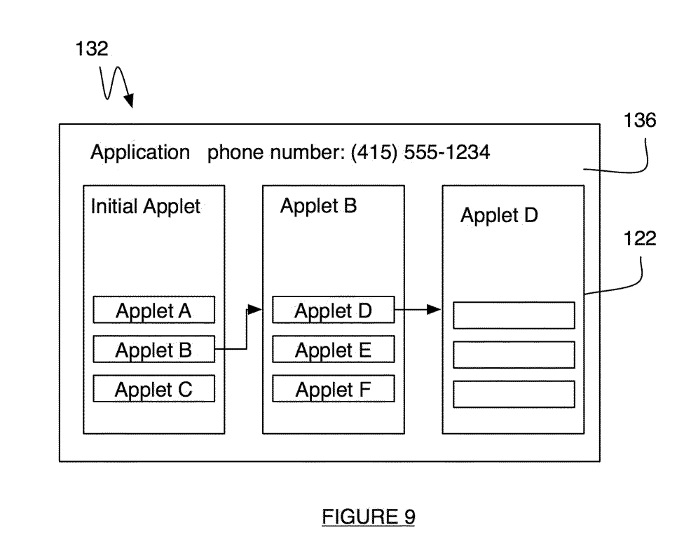

The customer portal 132 functions to provide an interface for customizing a container app no. The customer portal 132 preferably has a library of applets that a user may select from. In one variation, the customer portal is used by end users to create a customized application. In another variation, application designers create applications composed of a plurality of applets, and then these applications are distributed to end users. In the case that the library is substantially large, the customer portal 132 preferably has search functionality that enables searching or organizing the library of applets by name, popularity, rating, release date, recommended applets, category (business app vs. game app), functionality (utility tool such as recording app vs. a large application such as a major marketplace app), or any suitable search criteria. The customer portal 132 additionally includes functionality to purchase applets or simply select applets for use. The step of purchasing an applet may require a customer agreeing to a variety of service plans such as selecting usage limits, usage rate charges, selecting number of licenses (if multiple instances of an applet are required) or accepting any suitable contract or charges. The customer portal 132 preferably additionally includes a telephony application creation tool 136 that functions to allow a customer to organize and input settings for a container app and applets. The creation tool 136 preferably enables traversing a singular path of a phone tree model of the container app 110 as shown in FIG. 9. Each node is preferably presented for customization individually. The applet node customization may additionally occur at a URI that corresponds to the URI of the applet reference 120. The settings of applets and/or container app are additionally performed using the customer portal 132. As mentioned above, customization options are preferably imported into the customization platform 130 through a customization reference 122 that points to a form or software designed for setting up the applet. For example, an applet may require phone numbers, sound files, text (for text-to-speech messages), email addresses, selecting text-to-speech voice settings (e.g., voice type and speed), URIs, other applet references 120, or any suitable input. The customer portal 132 may have any suitable user interface such as drag-and-drop capabilities to add an applet reference 120 to a container app no, or using a flow chart or hierarchical view of the application. The customer portal 132 additionally includes functionality to provide feedback on applets such as allowing customer ratings of applets, writing reviews.

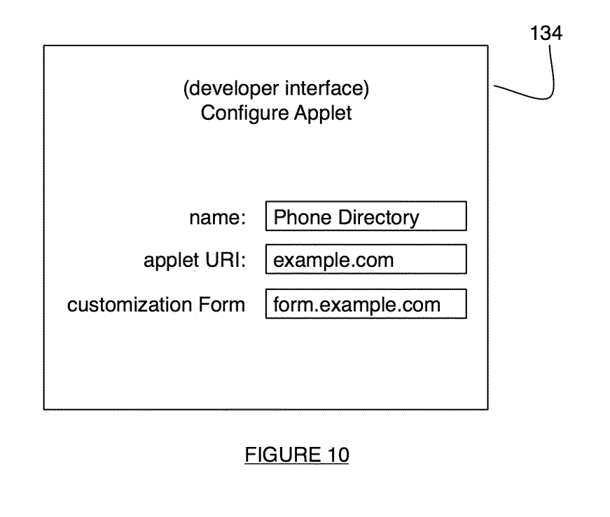

The developer portal 134 functions to allow a developer to add and manage an applet within the system as shown in FIG. 10. A developer is preferably able to add an applet to the customization platform 130 by providing an applet reference 120 that is preferably a URI of an executable telephony application. Since the applet is preferably operated by an outside party, the applet program or source code does not need to be uploaded to the customization platform 130. However, the source code may alternatively be uploaded and hosted internally in the system 100. A configuration reference 122 is additionally provided by a developer which functions to define the information that a customer may set to customize the applet. The configuration reference 122 is preferably a URI to a web form that is displayed within the customization platform 130 such as within an iframe. However, the customization platform 130 may alternatively direct a customer to a different website to complete the customization process. The configuration reference 122 may alternatively be a configuration applet such as a JAVA applet or flash applet that similarly functions to gather input from a customer. Configuration of an applet may affect changes on the developer side of the applet (outside of the system 100) such as by creating an account, uploading data, or affecting a specialized application for a user, or customization may alternatively alter the applet reference 120 by appending URI variables to the applet reference 120. The pricing model options of the applet are preferably set by a developer 134 within the developer portal 134. Other suitable settings such as security (http vs. https settings), or applet information (summaries graphics) may additionally be configurable by a developer.

The telephony application platform 140 functions to provide functionality of a telephony application to interface between with a telephony device. The telephony application platform 140 may alternatively or additionally include interfaces with telephony messaging services (e.g., SMS or MMS), email, fax, and/or any other suitable network. The telephony application platform 140 is additionally preferably able to allocate phone numbers for a container application. The telephony application platform 140 preferably is integrated with the customization platform 130. The telephony application platform 140 preferably includes call routers 142 that interface between a telephony device and a networked application. A call router 142 functions to initiate or receive calls from a telephony device and to connect to a deployed container app 110 and/or applet. The call router 142 is preferably connected to a Public Switched Telephone Network (PSTN) device over the PSTN network, such that the call router 142 can receive and make calls from PSTN-connected devices 21, such as landlines, cellular phones, satellite phones, or any other suitable PSTN-connected devices, as well as non-PSTN devices, such as Voice-Over-Internet-Protocol (VOIP) phones, SIP devices, Skype, Gtalk, or other Internet addressable voice devices. The call router 142 may alternatively or additionally function as or include a message router for use with short message service (SMS) messages. The call router 142 can preferably connect to an SMS network, such that it can receive and send messages from SMS network devices 21, cellular phones, computers, smartphones, or any suitable SMS network devices. The call router 142 may also send or receive text messages, multimedia messages, emails, faxes and other suitable PSTN-compatible communication messages. The call router 142 preferably communicates with the container app 110 and/or applet using an application layer protocol, more preferably using the HTTP, or secure HTTPS, protocol. The communication between the container app no and/or applet and the call router 142 is preferably stateless and any state information (e.g., call state) or data is preferably located in a URI or the request parameters, such as HTTP headers, GET URI parameters, POST request body parameters, or HTTP cookies. Available state information is preferably transmitted by call router requests to the container app 110 and/or applet for stateless processing, and the container app no and/or applet preferably stores no state. Alternatively, the container app no and/or applet may store local state information, such as databases or sessions, as is common in web development. The call router 142 preferably stores state information in call router resources. The call router resources are preferably accessible by the application server and other devices through a call router API. The call router 142 preferably associates each incoming phone number with a starting URI, The starting URI is preferably the location of the container app 110. Before a call is received at the call router 142, the starting URI is associated with the incoming call address (such as DID, SIP address, etc.) or by the application upon initiation of an outgoing call. The call router 142 can preferably send call data such as the caller number (obtained via Caller ID), caller geographic data (country, city, and/or state, zip) the number dialed, the time of the call, or any other suitable information or parameter.

### 3. Method for Running a Multi-Applet Telephony Application

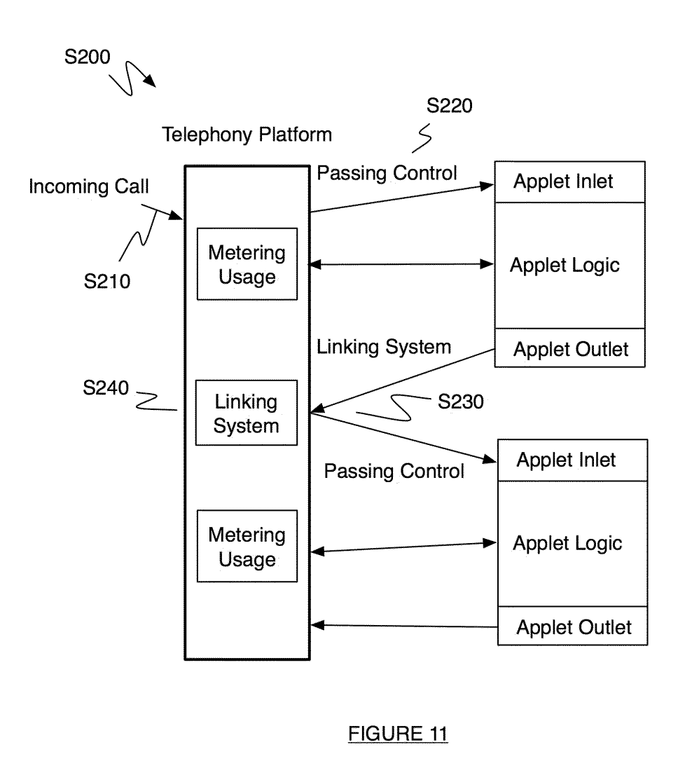

As shown in FIG. 11, a method S200 for running a multi-applet telephony application of a preferred embodiment includes receiving an application request to a number associated with an account of a telephony platform S210, directing application control to a first applet of an application of the account S220, passing application control from the first applet to a second applet of the account through a linking system S230, and metering use of the first applet and the at least second applet S240. The method S200 functions to allow an application to have the functionality of multiple applets linked so application control can be passed between applets. The method S200 further functions to allow highly customized telephony applications to use applets (or modules) developed and operated by any suitable party. The applets can preferably be customized within a container app (or some abstraction of overall flow between applets) that determines overall configuration in applet flow. An application configuration file may be created to create initial mapping of an application. The applets may vary in functionality and performance. The customization process is preferably facilitated by an online store, but any customization environment may alternatively be used. The method S200 further provides ways for applets to pass parameters and share state information. The different applets may be developed by any suitable entity such as third party developers or operators of the telephony platform. The method S200 is preferably implemented on the telephony platform substantially similar to the telephony platform described in US U.S. Patent Application publication no. 2009/0252159, filed Apr. 2, 2009, titled “SYSTEM AND METHOD FOR PROCESSING TELEPHONY SESSIONS” which is incorporated in its entirety by this reference, but the method may alternatively be used by any suitable telephony platform. The method further functions to enable an applet to be used by users on a usage based technology platform. An additional benefit of the method 5200 is that usage of an applet is individually metered which can preferably be used to simplify the payment process. Preferably, the design of the system, as described below, and the method of use allows for outside developers to easily create and operate telephony application applets without performing complicated tasks to manage state of the call or coordinating with other applet developers for how to communicate and collaborate within an application.

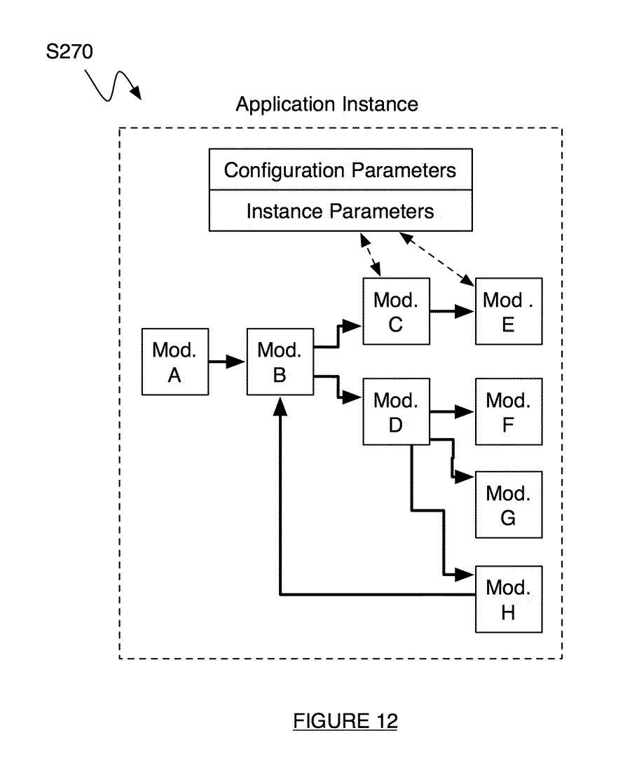

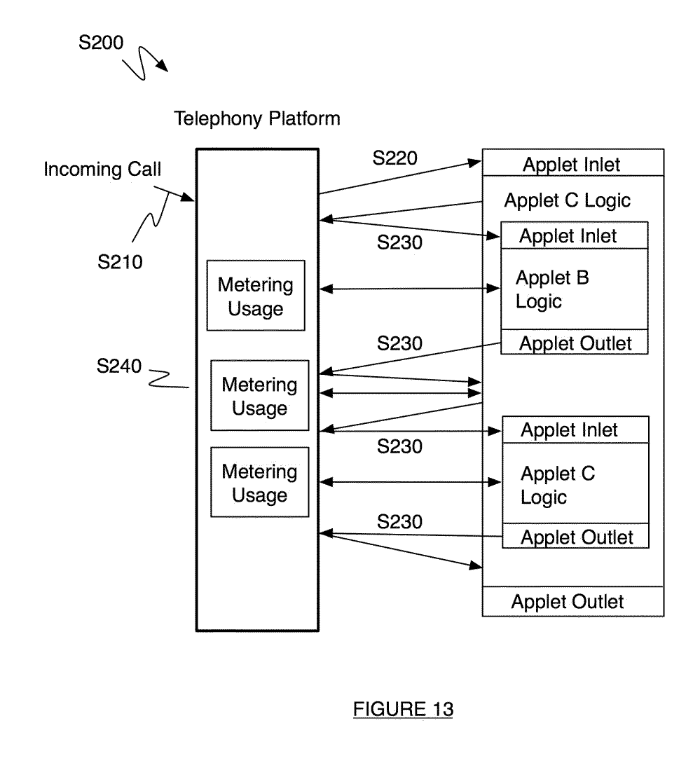

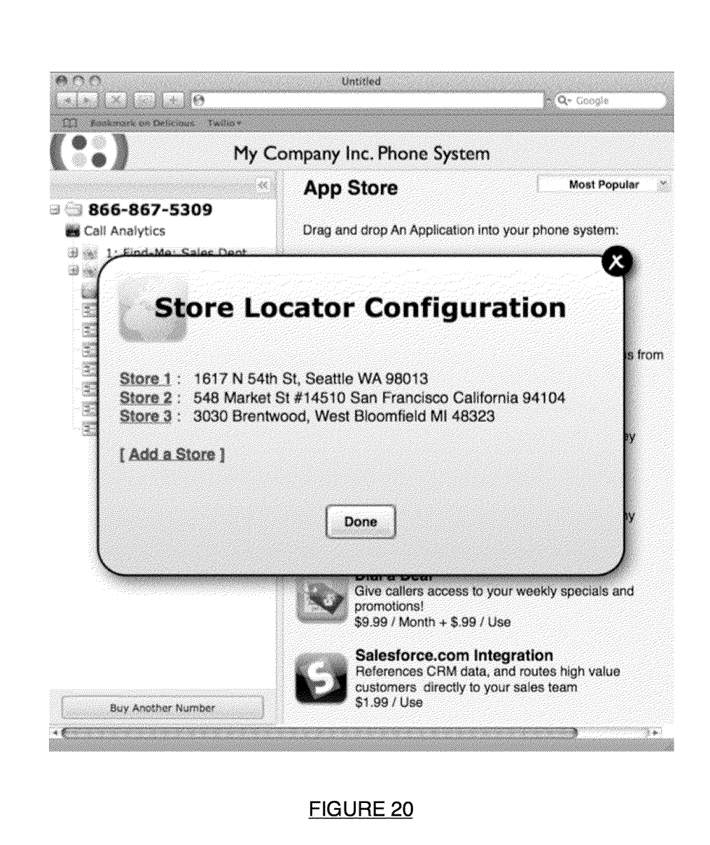

Step S210, which includes receiving an application request to a number associated with an account of a telephony platform, functions to handle an incoming request to the telephony platform. The application request is preferably an incoming phone call, which may be a phone call from the public switched telephone network (PSTN), a voice over internet protocol (VoIP), or any suitable telephone network. The application request may alternatively be a request made from a telephony message such as a message received over short message service (SMS), a multimedia messaging service (MMS), or any suitable messaging service. As another alternative, the application request may be over fax or any suitable communication channel. Additionally or alternatively, the application request may be initiated from a web application or a server, such as in the example where an outgoing phone call is initiated by the web application. The incoming application request is preferably directed to an application assigned to a phone number. The application is preferably composed of at least one applet. The at least one applet is preferably configured to direct application control to at least one other applet. The second applet that the first applet directs application control to may be determined through the application logic of the applet. More preferably, the application is preconfigured to include a plurality of applets that have a configured flow as shown in FIG. 12. A user customized application which may be described as being defined by a “container application”, may be setup through a user interface that links the different applets and defines the functionality and operation parameters of the applets as shown in FIGS. 19 and 20. The applets may be developed by any suitable party. For example, the functionality of an application may utilize one applet by a ‘company A’ which can pass application control to a second applet by ‘company B’. These applets are preferably stored outside of the telephony platform (e.g., on a server determined by the respective developers/owners), but the applets may alternatively be stored within the telephony platform. Additionally, similar to how one application may be configured to use a plurality of applets, an applet may itself be configured to use a plurality of other applets as shown in FIG. 13.

Step S220, which includes directing application control to a first applet of an application of the account, functions to direct the telephony platform to communicate with the first applet to determine application logic. Application control preferably includes a server hosting the applet communicating with a call router of the telephony platform or any other suitable portion of a telephony platform. Directing application control to the first applet preferably includes having the call router communicate with the applet at a Universal Resource Identifiers (URI). The applet is preferably stored on an application server but the applet may alternatively be stored in any suitable location. Applets preferably have a specified initial URI (i.e., an applet reference or inlet). The URI may be a resource indicator for Hypertext Transfer Protocol (HTTP), Session Initiation Protocol (SIP) or any suitable communication protocol. As described more below, the initial URI may additionally be used to pass operation parameters to the applet. In some variations, the operation parameters may be information to determine what applet will be passed application control. In this variation, a single URI can be used to define the application configuration for a plurality of applets.

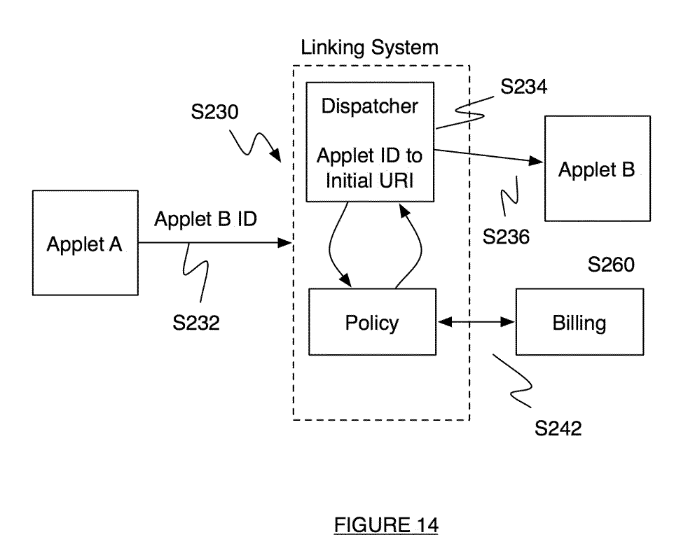

Step S230, which includes passing application control from the first applet to a second applet of the account through a linking system, functions to transfer the application control as viewed by the telephony platform to a second applet. The passing of application control is preferably initiated through programmatic logic of the first applet such as entering an operational state or some action. This applet state or action can be thought of an outlet. There may be a plurality of outlets of which application control may be passed to varying applets. As an example, a phone tree applet may have the actions of various dual-tone multi-frequency (DTMF) (or alternatively speech recognition phrases) assigned to different applets that will be passed control if that action is taken. As discussed above, the first and second applet may be operated by any suitable party, and the second applet preferably does not need to have any knowledge of the first applet to be passed control. Operation of the first applet is additionally independent of the second applet, except that the mechanism of the linking system may require being implemented by the first applet. The linking system may be operated in a number of ways. In a first variation, the linking system includes performing a URI redirect to the initial URI of the second applet. For example, the first applet will issue a command to the telephony platform to next communicate with the initial URI of the second applet instead of a URI of the first applet. The redirect URI (the initial URI of the second applet) may be stored by the first applet. The URI redirect may alternatively be preloaded through the initial URI of the first applet. So one initial URI may include all the application logic to use a plurality of applets by embedding the application configuration parameters in the initial URI of the first applet. As a second variation shown in FIG. 14, the linking system may include using a dispatcher engine that performs the steps of passing an applet identity code of the second applet to a dispatcher engine of the telephony platform S232; converting the code to a URI for the second applet S234; and directing call control to the second applet at the URI for the second applet S236. The applet identity code is any suitable representation of the second applet. Each applet usable by the telephony platform is preferably assigned an applet identity code. The dispatcher engine is preferably a service ran on the telephony platform that maps applet identity codes to initial URI's of applets. The applet identity codes functions to allow the location of the applet to be aliased so that a developer may change the location and setup of an applet without breaking links to an initial URI that other applets include. The dispatcher engine may additionally provide a level of security such that use of an applet may not be achieved if it is not allowed. As yet another variation, the dispatching engine may store applet-to-applet flows in an application configuration datastore (i.e., a container app), and the first applet preferably signals that the next applet (or applet of a particular outlet) should be transferred control. In this variation, the first applet may not have knowledge of what applet is being linked to. The application configuration datastore preferably includes aliasing of the initial URI's of applets and will direct application control to appropriate initial URI. The dispatching engine preferably additionally works in cooperation with a policy engine that determines if application control is allowed and/or a billing engine that uses a designated usage model for billing management of various parties as shown in FIG. 14. The policy engine and the billing engine are discussed below. The dispatcher engine and the policy engine preferably cooperate to determine where application control should be directed and if application control should be allowed for the particular user account. The billing engine is preferably used in combination with the policy engine to determine billing factors that would prevent applet access.

Step S240, which includes metering use of the first applet and the at least second applet, functions to account for the different applets of the application separately. The first and second applet usage of the telephony application for a user account is preferably individually metered. The independent metering can preferably be achieved because use of the telephony platform during application control by each applet is preferably isolated and accountable. The telephony platform (e.g., a call router) can preferably track what applet URI's are being used for application control, and more preferably the dispatching engine or the policy engine preferably tracks application control. In addition to metering application control, actions outside of application control (asynchronous usage) may be monitored. For example, API calls made by an applet or other use of the telephony platform that do not relate to an instance of application control may be included in the metered activity. Metering preferably includes maintaining usage statistics. The metrics used for metering preferably may include per “period use” (e.g., unlimited usage for one month), amount of usage in a fixed period (e.g., 100 minutes of call time per month or 500 text messages in a month), or a usage limit (e.g., 500 text messages), or any suitable usage model. Alternatively, the metering may include noting that an applet is in use during a particular period. This may be used for a usage model with unlimited use in a time period. Preferably the comparison of time period of unlimited use and the current timeis used in verifying permission for the account to use an applet. For example, if a usage model is set so that the applet may see unlimited use during month period, the metering preferably notes that the month is being used in a particular month, and a policy engine preferably verifies permission for an account to be used that month (e.g., check if the current date is included in the month of unlimited use). This particular alternative may be further used during the configuration of telephony application. A particular applet may not be prevented from being configured within a telephony application until the current time period is paid for. The metric used to measure usage of the first applet and the second applet can preferably differ, such that the usage model of each applet may be individually assigned.

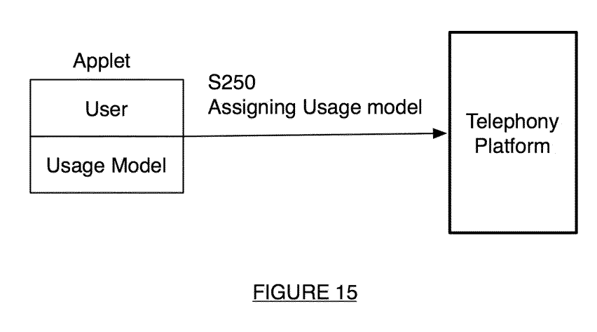

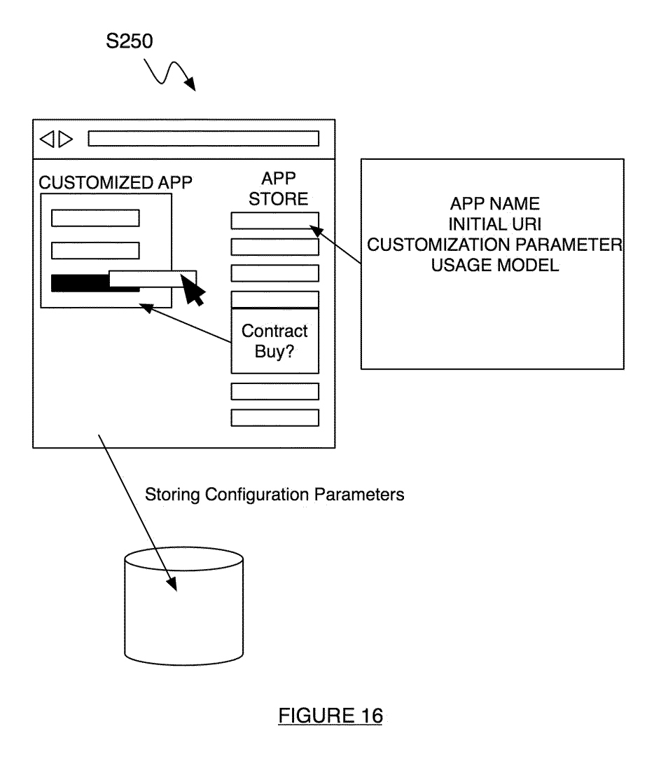

As an additional step of the preferred embodiment shown in FIGS. 15 and 16, the method S200 may include assigning a usage model of the account for the first applet and the second applet S150; and prior to directing application control to the initial URI of the second applet, a policy engine verifying permission for the account to use the second applet S242. The usage model of an applet is preferably assigned during a prior configuration of the application and the information is stored for the application of the account. The usage model may be an agreement of what resources can and cannot be used but preferably includes a billing agreement that specifies a pricing model for the use of the applet. When verifying permission, the policy engine is preferably checking that the users usage model is being followed. Conditions for permission may include having a fully paid account, having current billing information, having funds in an account, or any suitable condition. Other permission rules may additionally be included such as categorization of user, banned user lists or any suitable permission setting. In some cases the policy engine may need to communicate with the billing engine to obtain information pertinent to the rules for permitting usage. The policy engine is preferably used when the linking system is being used when passing of application control is made between two applets. The policy engine and the dispatcher engine may be used in any suitable order or configuration.

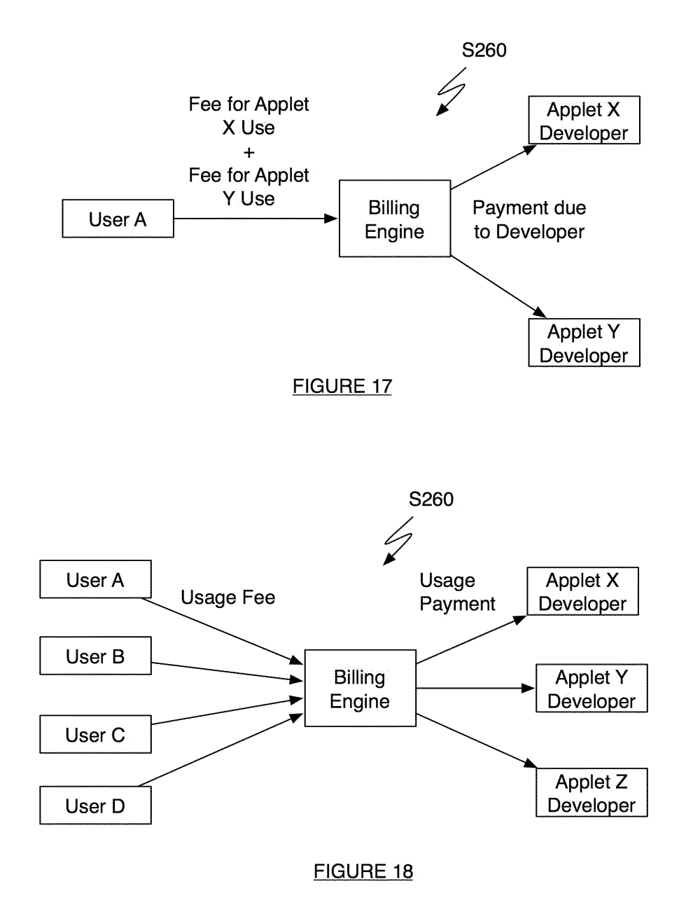

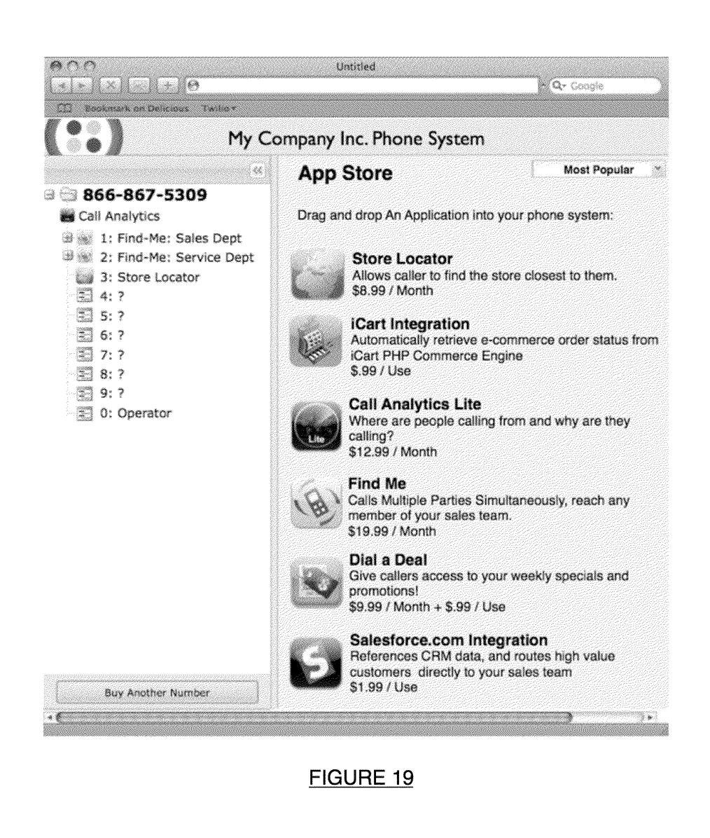

As an additional step of the preferred embodiment, the method S200 may include a billing engine that performs the steps including transferring payment from an account based on a usage model for the first applet and the second applet S260, which functions to charge accounts and/or pay entities based on independent usage models and metered usage by a first applet and at least second applet. The billing engine preferably provides a simplified billing process for applications composed of multiple applets. A user account may enter numerous subscriptions/contracts with different entities when using an application with a plurality of applets, but the billing engine is preferably used to consolidate the different usage models so that the user pays a single bill for all applet use as shown in FIG. 17. Similarly, developers, owners, or any entity associated with the applet has simplified billing procedure by preferably having the cost of telephony platform use and payment from a plurality of user accounts consolidated into a single payment as shown in FIG. 18. Preferably, transferring of payment from an account includes charging the user account for combined usage of the first applet and the at least second applet as indicated by the metered use of the first applet and at least second applet and distributing payment to an entity of the first applet based on usage record of the first applet and distributing payment to an entity of the second applet based on a usage record of the second applet. When distributing payment to an entity of an applet, there may be some portion of payment that the telephony platform receives, and thus the payment delivered may factor in this cost. This preferably enables the telephony platform provider to act as a single point of billing even though each user may have numerous contracts with different applet operators. The user account instead of paying numerous bills each with possibly different usage plans, pays just the telephony platform provider, and the developers. Similarly, operators of the applets receive a payment from the telephony platform instead of developing their own infrastructure to track usage of the applet and also implementing their own billing system. Additionally, the billing engine preferably cooperates with the policy engine so that the policy engine may verify the user account has satisfied the billing requirements. These billing requirements may be for the overall application but may be for each applet individually.

As previously discussed, the method may include sharing state information of the first and the at least second applet S270. Each applet can preferably have individual configuration parameters, which may be stored by the applet operators, on the telephony platform, or through any suitable device. The configuration parameters combine to form a configuration state. Additionally, the application as defined by the collection of applets may have configuration parameters. The application configuration parameters may be the flow of the applets in the application, but may alternatively be variables that are globally available to the applets of the application. For example, an account ID, a call number, text message, and/or any suitable parameter may be available to the applets. The configuration parameters in one variation are passed through the initial URI's of the applets that is used when passing application control. For example, settings for a simultaneous ring app may have two phone numbers, 415-555-1234 and 415-555-6789. Rather than storing and accessing these settings from a database the applet reference may have them embedded in the reference such as:

http://twimlets.com/simulring?PhoneNumbers [0]=415-555-1234&PhoneNumbers[1]=415-555-6789&.

As another variation, the parameters may be accessible through an API call to the telephony platform where the configuration parameters are stored. A presassigned key value pairing may be provided for use by the applets. In a variation where multiple instances of the same applet are used, settings may be setup globally for all instances or saved individually for each instance of an applet. Settings and information that may be collected may include phone numbers, email addresses, sound files, text (to read with a text-to-speech service), URIs to other media, other applet references (initial URI's), or any suitable inputs. In addition to configuration parameters that may be set for every application use, instance parameters (i.e., parameters that are unique for every phone call or text message or application use) may additionally be shared through similar techniques. After application control has been passed to the second applet, then telephony platform requests are preferably sent to a URI of the second applet.

Additionally, the telephony platform may include a notification engine that preferably performs the step of notifying an applet of activity on the telephony platform. The notification engine preferably sends an event notification during any suitable event. Such events may include an incoming call to an application, an end to an application instance, a billing event, or any suitable event.

### 4. Method for Providing Metered API Access

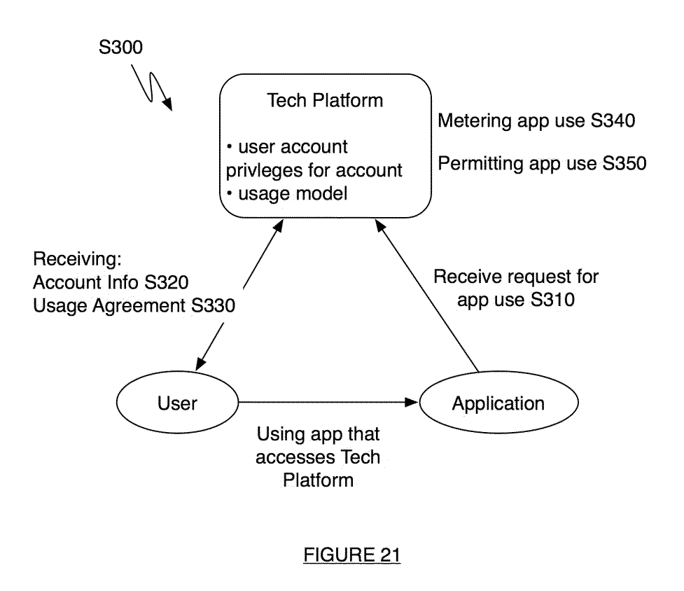

As shown in FIG. 21, a method S300 for providing metered API access of a second preferred embodiment preferably includes receiving a request to add an application for use on a platform S310, receiving user account information for the platform S320, receiving usage agreement information for the user account S330, metering the application usage for the account S340, and permitting use of a platform resource for the user account according to the metered usage and usage agreement S350. The method S300 preferably functions to enable a single application to be used by users of a usage based technology platform. The technology platform may be any paid platform such as an API (a REST API, SOAP API or any suitable API) or may alternatively have usage limits. More preferably, the technology platform is a paid or usage based platform where usage of the technology platform either by the user or of the application is of importance to the services provided. There may be usage limitations or alternatively billing requirements based on usage. Method S300 can preferably by used with the method S300 above for the applets of an application, and method S300 may additionally be used for a telephony platform, and used in a manner substantially similar to the method S300. But the method S300 can preferably be used with standalone applications such as a third party mobile app that uses a web service. For example a social network that wants to charge for third party mobile phone application access to the social network API could use method S300. The method S300 can preferably be performed by a system as in the above method that includes a policy engine, a billing engine, and/or a dispatcher engine. The method S300 may additionally be extended for use with a plurality of applications associated with a user account, where the user is accountable for different usage models of each application, as in the method S300.

Steps S310, S320, and S330, which includes receiving a request to add an application for use on a platform, receiving user account information for the platform and, receiving usage agreement information for the user account, functions to authorize an application to access resources of an account and provide suitable usage metering. This process can be setup similar to other authorization processes such as oauth. However, the process additionally includes receiving usage agreement information. The usage agreement information may be a variety of items depending on the particular technology platform. Preferably, the usage agreement information includes billing information and an agreed upon usage plan. The usage plan may be a fee per time period, a fee per amount of resource use, fee per amount of time, or any suitable usage model. In another variation, the usage agreement information may be an acknowledgement to the amount of use available to the user, such as a limit of data usage per time period. The Steps S310, S320, and S330 preferably result in an application receiving access to account resources on the technology platform and a usage model being setup for the user account of the application.

Step S340, which includes metering the application usage for the account, functions to create a record of the usage of the application by the user account. The metering is preferably substantially similar to the metering as performed in method S300. Metering of application usage may additionally be targeted to particular actions such as the number of times an API call is made or use during a particular time period. The technology platform preferably meters the activity by the application.

Step S350, which includes permitting use of a platform resource for the user account according to the metered usage and usage agreement, functions to regulate the use of the application by the user. A policy engine substantially similar to the one described above is preferably used for this step. The policy engine may additionally communicate with a billing engine to determine permission. In the method S300 above, this step preferably includes passing application control to an applet (or application). In other alternatives, the permitting use of a platform may include allowing specific API calls or resources to be used by an application. Depending on the usage agreement information this may be limited to specific API calls or be overall access to the technology platform. When permission is not allowed, any suitable error message or action may be taken. Depending on the usage agreement, when access is not allowed because usage has reached a limit of the plan, a billing engine may automatically charge a user account to enable uninterrupted use of the technology platform. A billing engine may additionally perform steps substantially similar to the billing steps of method S300. The platform preferably collects payment from a user account and then distributes payment to the entity associated with the application (e.g., the developer). Users that utilize multiple applications on a technology platform can preferably receive a single bill, and developers of applications can similarly receive a consolidated payment for all users delivered by the telephony platform.

### 5. System for Customized Telephony Applications

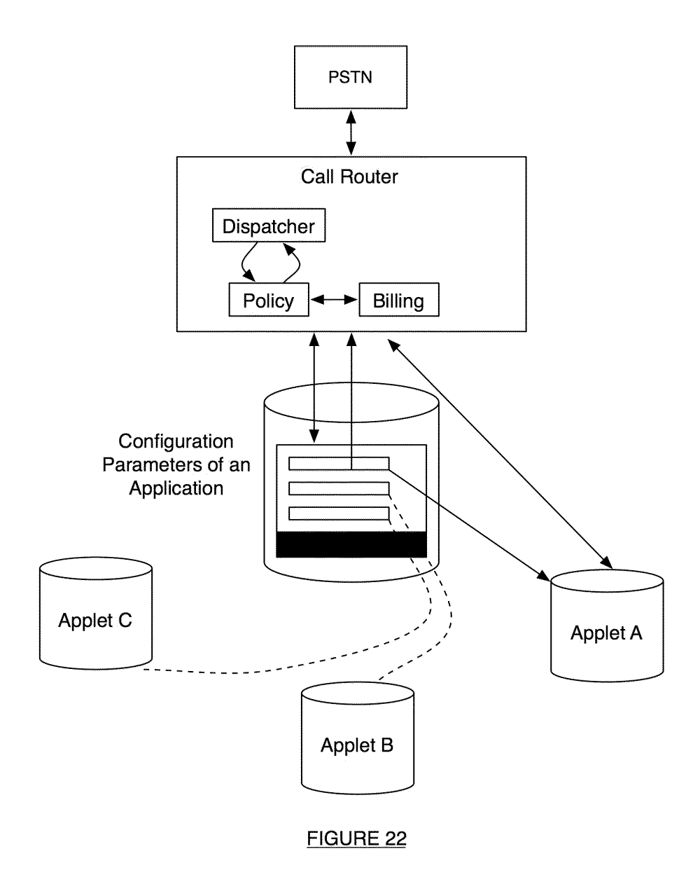

As shown in FIG. 22, a particular system for performing the above methods preferably includes a telephony platform with a linking system and a plurality of applets. The linking system preferably includes a dispatcher engine, a policy engine and a billing engine, but may contain any alternative combination or alternative components. The dispatcher engine preferably works to determine what initial URI to pass application control. The policy engine preferably enforces permissions and can communicate with the billing engine to determine billing related restrictions.

The call router functions to initiate or receive calls from a telephony device and to connect to a deployed container app and/or applet. The call router is preferably connected to a Public Switched Telephone Network (PSTN) device over the PSTN network, such that the call router can receive and make calls from PSTN-connected devices 21, such as landlines, cellular phones, satellite phones, or any other suitable PSTN-connected devices, as well as non-PSTN devices, such as Voice-Over-Internet-Protocol (VOIP) phones, SIP devices, Skype, Gtalk, or other Internet addressable voice devices. The call router may alternatively or additionally function as or include a message router for use with short message service (SMS) messages. The call router can preferably connect to an SMS network, such that it can receive and send messages from SMS network devices, cellular phones, computers, smartphones, or any suitable SMS network devices. The call router may also send or receive text messages, multimedia messages, emails, faxes and other suitable PSTN-compatible communication messages. The call router preferably communicates with the application or applets using an application layer protocol, more preferably using the HTTP, or secure HTTPS, protocol. SIP or any suitable internet protocol may alternatively be used. The communication between the applet and the call router is preferably stateless and any state information (e.g., call state) or data is preferably located in a URI or the request parameters, such as HTTP headers, GET URI parameters, POST request body parameters, HTTP cookies, or in configuration parameters of the application or applet. The call router preferably stores state information in call router resources. The call router resources are preferably accessible by the application server and other devices through a call router API. The call router preferably associates each incoming phone number with a starting URI, The starting URI is preferably the location of the application or the initial applet. Before a call is received at the call router, the starting URI is associated with the incoming call address (such as DID, SIP address, etc.) or by the application upon initiation of an outgoing call. The call router can preferably send call data such as the caller number (obtained via Caller ID), caller geographic data (country, city, and/or state, zip) the number dialed, the time of the call, or any other suitable information or parameter.

The applet is preferably a resource such as document containing telephony instructions interpreted by the call router. The instructions are preferably translated into actions and handling of the telephone call, text message or other telephony communication. An applet may provide any suitable functionality. Some exemplary applets may include a store locator, an e-commerce order status app, call analytics, a find-me application, an RSS feed powered app, a call directory and routing app, an advertising application that calls another applet reference after playing an advertisement, a voicemail app, menu app, a simultaneous call app, a find me app that calls a list of numbers until one of them is answered, or any suitable application. Developer applets can be remotely hosted at a site selected by the developer utilizing any suitable architecture, yet the applets can be made available in a single marketplace to provide better exposure, and lower the barrier of acceptance by potential customers.

The system may additionally include a billing engine that functions to manage and track telephony platform usage by an applet to appropriately charge a user. The billing engine preferably tracks all applets according to set billing policies agreed to by a customer in a usage model. This may include tracking time of use, number of uses, or according to any suitable subscription model. The billing engine preferably consolidates all applet fees for both the customers and the developers. It is envisioned that a customer may have multiple service agreements and contracts for various applets. The bills for the various applets are preferably consolidated into a single, periodic bill created and sent out by the billing engine. Similarly, it is envisioned that a developer may have a plurality of customers with varying agreements. The payments from the various customers are preferably consolidated into a single, periodic payment. Account information and billing information is preferably stored in any suitable database.

An alternative embodiment preferably implements the above methods in a computer-readable medium storing computer-readable instructions. The instructions are preferably executed by computer-executable components preferably integrated with a application platform. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for creating a telephony application with multiple applets, wherein the applets operate through a telephony platform, the method comprising:
instantiating at least a first applet in an application configuration;
adding an applet reference of a second applet in an outlet of the first applet;
wherein the applet reference directs application control to a second applet upon the first application triggering the outlet;
mapping a telephony endpoint to the first applet in an application configuration; and
deploying the application on the telephony platform wherein an incoming communication to the telephony endpoint is routed to the first applet.

2. The method of claim 1, wherein an applet reference is a universal resource identifier (URI) to an applet.

3. The method of claim 1, wherein the telephony endpoint is for telephony number using a voice protocol.

4. The method of claim 1, wherein the telephony endpoint is for an endpoint using a telephony messaging protocol.

5. The method of claim 1 wherein mapping a telephony endpoint further includes mapping a plurality of telephony endpoints to corresponding applet references that are specific for the protocol of the telephony endpoint.

6. The method of claim 1, further comprising customizing applet instance variables of an applet that are initialized each time an instance of the applet is created.

7. The method of claim 6, wherein customizing the applet instance variables includes embedding instance variables of an applet in the reference of the applet.

8. The method of 6, further comprising presenting a customization interface that receives user input of at least one applet instance variable and user input on the applet reference to add to an outlet of an applet.

9. The method of claim 8, wherein presenting an interface includes composing a tree model of the application as defined by the connections between applets indicated by links between an applet outlet of an applet and an applet referenced in the applet outlet.

10. The method of claim 9, further comprising delegating privileges to customize at least one applet in the tree model to a second user.

11. The method of claim 9, wherein composing a tree model includes dynamically determining nodes in the tree by traversing the application references in an applet starting with the first applet.

12. The method of claim 9, wherein presenting an interface includes modally presenting an instance variable customization interface of an applet.

13. The method of claim 12, wherein presenting an interface includes traversing the tree model to present an instance variable customization interface.

14. The method of claim 13, wherein traversing the tree model includes receiving user selection of an inlet or an outlet of a current applet and modally presenting an applet associated with the reference of the inlet or outlet.

15. A method for creating a multi-applet application, wherein applets operate through an application platform, the method comprising:
instantiating at least a first applet in an application configuration;
adding an applet reference of a second applet in an outlet of the first applet;
wherein the applet reference directs application control to a second applet upon the first application triggering the outlet;
mapping an communication endpoint to the first applet in an application configuration;
obtaining usage agreement information of a user account for the application;
deploying the application on the application platform; and
metering the application of the user account.

16. The method of claim 15, wherein metering the application of the user account includes metering the first applet and second applet independently.

17. The method of claim 16, further comprising transferring payment from the user account based on a usage model for the first applet and the second applet and the usage agreement information for the application.

18. The method of claim 17, wherein the usage agreement information is a single agreement for the usage of the application; and wherein metering is performed for each applet of the application.

19. The method of claim 18, wherein the endpoint is a telephony endpoint, and the application is deployed on a telephony application platform.

20. The method of claim 15, further comprising customizing applet instance variables of an applet that are initialized each time an instance of the applet is created; and presenting a customization interface that receives user input of at least one applet instance variable and user input on the applet reference to add to an outlet of an applet.

21. The method of claim 20, wherein presenting an interface includes composing a tree model of the application as defined by the connections between applets indicated by links between an applet outlet of an applet and an applet referenced in the applet outlet; and traversing the tree model and modally presenting an instance variable customization interface of an applet.
